(19) United States
(12) Patent Application Publication
(10) Pub. No.: US 2019/0292818 A1
(43) Pub. Date: Sep. 26, 2019

(54) VEHICLE DOOR SYSTEM WITH POWER-OPERATED DOOR PRESENTER AND DOOR CHECK MECHANISM WITH RETENTION FUNCTION

(71) Applicant: MAGNA CLOSURES INC., Newmarket (CA)

(72) Inventor: Francesco CUMBO, Pisa (IT)

(21) Appl. No.: 16/357,638

(22) Filed: Mar. 19, 2019

Related U.S. Application Data
(60) Provisional application No. 62/646,555, filed on Mar. 22, 2018.

(51) Int. Cl. E05B 81/70; E05F 15/622; E05F 15/614; E05B 81/06; E05B 81/38; E05B 81/14

(52) U.S. Cl. CPC E05B 81/70; E05F 15/622; E05F 15/614; E05B 81/14; E05B 81/77; E05B 81/38; E05B 81/06

(57) ABSTRACT

A vehicle door and power door system therefor is provided. The power door system includes a power-operated door presenter assembly operable for moving the vehicle door relative to a vehicle body from a closed position to an open presented position and a power-operated door check mechanism for selectively maintaining the vehicle door in the open presented position until the door is intentionally moved toward a fully open position or toward the closed position.

### CROSS-REFERENCE TO RELATED APPLICATION

This application claims the benefit of U.S. Provisional Application Ser. No. 62/646,555, filed Mar. 22, 2018, which is incorporated herein by reference in its entirety.

### FIELD

The present disclosure relates generally to vehicle door systems for motor vehicles and, more particularly, to a power vehicle door system including a power-operated door presenter operable for moving a vehicle door relative to a vehicle body from a closed position to an open presented position and a door check mechanism for selectively maintaining the vehicle door in the open presented position.

### BACKGROUND

This section provides background information related to the present disclosure which is not necessarily prior art.

Passenger doors on motor vehicles are typically mounted to a body of the motor vehicle by upper and lower door hinges for swinging movement (“swing doors”) about a generally vertical pivot axis passing through the upper and lower hinges. In view of increased consumer demand for motor vehicles equipped with advanced comfort and convenience features, many current motor vehicles are now provided with passive keyless entry systems to permit locking and release of the passenger doors without the use of traditional key-type manual entry systems. In this regard, some of the more popular features now provided with vehicle door systems include power locking/unlocking and power release. These “powered” features are typically integrated into a primary latch assembly mounted to the passenger door, with the features typically configured to include a latch mechanism, a latch release mechanism and at least one electric actuator. As is known, movement of the passenger door to its closed position causes the latch mechanism to engage a striker (mounted to the vehicle body) and shift the primary latch assembly into a latched mode. To subsequently release the passenger door for movement from its closed position toward an open position, an electric “power release” actuator can actuate the latch release mechanism to mechanically release the striker from the latch mechanism and shift the primary latch assembly into an unlatched mode.

As a further advancement, power door actuation systems have been developed to include systems known as door presenter systems, wherein door presenter systems are configured to include a power-operated door presenter assembly operable to “present” the passenger door by opening it only a predetermined amount to a partially-open position so as to allow subsequent manual movement of the door to its fully-open position by a user. Although known door presenter systems are useful in presenting the passenger door to assist the user in opening the passenger door, problems can arise, such as when parked on a hill and/or in windy conditions, for example. It the passenger door is presented with the vehicle facing up a hill, if the user is not in immediate grasping contact with the passenger door, the passenger door may swing open under the force of gravity, which could possibly damage the door hinges or cause the passenger door to make impact with an adjacent object, thereby causing damage to the passenger door. The same result can occur in windy conditions if the wind catches the presented passenger door prior to the user grasping the passenger door. In addition to the aforementioned issues, if the user places their fingers between the passenger door and the vehicle body to grasp the door, if the door is suddenly urged toward a closed direction, such as under gravity or due to wind, the user's fingers may become pinched.

In view of the above, there remains a need to develop alternative power door presenter systems which overcome limitations associated with known power door actuation systems, such as by preventing passenger doors from opening freely under the force of gravity, wind, or at any unwanted time while the user is not in active control of the passenger door, and further to prevent unintended closing of the passenger door upon being presented, as well as provide increased applicability while reducing cost and complexity associated therewith.

### SUMMARY

This section provides a general summary of the present disclosure and is not a comprehensive disclosure of its full scope or all of its features, aspects and objectives.

It is an aspect of the present disclosure to provide a power door system including a power-operated door presenter assembly operable for moving a vehicle door relative to a vehicle body from a closed position to an open presented position and a power-operated door check mechanism for selectively maintaining the vehicle door in the presented position until the user actively grasps the door for movement toward a fully open position or toward the closed position.

It is a further aspect of the present disclosure to prevent inadvertent movement of the vehicle door in a closing direction upon being moved to the presented position.

It is a further aspect of the present disclosure to prevent inadvertent movement of the vehicle door in an opening direction upon being moved to the presented position.

In a non-limiting embodiment, a power vehicle door system for pivoting a vehicle door relative to a vehicle body from a closed position to a partially open presented position and for selectively maintaining the vehicle door in the open presented position is provided. The power vehicle door system includes a power-operated door presenter assembly having a presenter housing mounted to one of the vehicle body and the vehicle door and having an extensible member and a presenter actuator for actuating movement of the extensible member between a retracted position corresponding to the closed position of the vehicle door and an extended position corresponding to the partially open presented position of the vehicle door. The power door system further includes a power-operated door check mechanism separate from the power-operated presenter assembly. The power-operated door check mechanism has a door check housing mounted to one of the vehicle body and the vehicle door and a catch and a catch actuator for actuating movement of the catch between a disengaged position and an engaged position. The catch actuator is configured to maintain the catch in the disengaged position when the vehicle door is in the closed position and is configured to maintain the catch in the engaged position when the vehicle door is in the partially open presented position.

In accordance with a further aspect, the catch actuator can be configured to move the catch from the engaged position to the disengaged position when the vehicle door is indicated as being under manual control of a user.

In accordance with a further aspect, the presenter actuator can be configured to move the extensible member from the extended position to the retracted position when the vehicle door is indicated as being under manual control of a user.

In accordance with a further aspect, the catch actuator can be configured to maintain the catch in the engaged position, while in the partially open presented position, when the vehicle door is indicated as not being under manual control of a user.

In accordance with a further aspect, the presenter actuator can be configured to maintain the extensible member in the extended position, while in the partially open presented position, when the vehicle door is indicated as not being under manual control of a user.

In accordance with a further aspect, the catch actuator can be configured to allow the catch to return to the disengaged position when the vehicle door is manually returned from the partially open presented position to the closed position.

In accordance with a further aspect, the presenter actuator can be configured to allow the extensible member to move from the extended position to the retracted position when the vehicle door is manually returned from the partially open presented position to the closed position.

In accordance with a further aspect, the power door system can further include a control module in operable communication with the power door presenter assembly and the power door check mechanism, wherein the control module can be configured to receive a signal from a sensor and to provide a signal to the power door presenter assembly and to the power door check mechanism indicating the vehicle door is under manual control of the user, thereby causing the power door presenter assembly to return to its retracted position and causing the power door check mechanism to return to its disengaged position.

In accordance with a further aspect, the power door presenter assembly can be mounted on the door and the power door check mechanism can be mounted on the vehicle body.

In accordance with a further aspect, a vehicle door configured for pivoting movement relative to a vehicle body is provided. The vehicle door includes a door panel structure and a power door system for pivoting the vehicle door relative to the vehicle body from a closed position to a partially open presented position and for selectively holding the vehicle door in the presented open position. The power door system includes a power presenter assembly and a power door check mechanism in operable communication with one another. The power presenter assembly is mounted to one of the vehicle body and the door panel structure and has an extensible member and a presenter actuator for actuating movement of the extensible member between a retracted position corresponding to the closed position of the vehicle door and an extended position corresponding to the partially open presented position of the vehicle door. The power door check mechanism is mounted to one of the vehicle body and the door panel structure and has a check arm and a check actuator configured to move the check arm between a disengaged state and an engaged state. The check actuator is configured to maintain the check arm in the disengaged state when the vehicle door is in the closed position and the check actuator is configured to maintain the check arm in the engaged state when the vehicle door is in the partially open presented position.

In accordance with a further aspect, a method of controlling movement of a vehicle door between a closed position, a partially open presented position, and an open position relative to a vehicle body with a power door presenter assembly configured to selectively move from a retracted position, corresponding to the vehicle door closed position, to an extended position, corresponding to the partially open presented position, and a power door check mechanism configured to move from a disengaged state to release the vehicle door to an engaged state to selectively hold the vehicle door in the partially open presented position is provided. The method includes maintaining the power door presenter assembly and the power door check mechanism in a de-activated (unactuated) state corresponding to the retracted position of the power door presenter assembly and the disengaged state of the power door check mechanism while the door is intended to remain in the closed position. Further, selectively actuating the power door presenter assembly to move the power door presenter assembly from the retracted position to the extended position to move the vehicle door to the partially open presented position. Further yet, selectively actuating the power door check mechanism in coordination with the actuation of the power door presenter assembly to move the power door check mechanism from the disengaged state to the engaged state to hold the vehicle door in the partially open presented position, thereby assuring the vehicle door does not inadvertently swing open, such as under the influence of wind or gravity.

In accordance with a further aspect, the method can further include selectively actuating the power door check mechanism to move from the engaged state to the disengaged state in response to an indication that the vehicle door is under the manual control of a user, thereby allowing the user to manually grasp and open the vehicle door upon being presented, as desired.

In accordance with a further aspect, the method can further include selectively actuating the power door presenter assembly to move from the extended position to the retracted position in response to an indication that the vehicle door is under the manual control of a user, thereby removing the power door presenter from possible, unwanted obstruction or damage.

In accordance with a further aspect, the method can further include configuring the power door presenter assembly and the power door check mechanism in operable communication with an electronic control module and coordinating actuation of the power door presenter assembly and the power door check mechanism via signals from the electronic control module, wherein the coordinated actuations can be simultaneous or staggered relative to one another, as desired for the intended application or as desired for the environmental conditions, i.e. wind conditions, incline of vehicle.

In accordance with a further aspect, the method can further include maintaining the power door check mechanism in the engaged state in response to the electronic control module indicating the vehicle door, while in the partially open presented position, is not under manual control of a user, thereby preventing unwanted sudden opening or closing of the vehicle door.

### BRIEF DESCRIPTION OF THE DRAWINGS

These and other aspects and advantages of the present disclosure will be readily appreciated, as the same becomes better understood by reference to the following detailed description when considered in connection with the accompanying drawings wherein:

FIG. 1A illustrates an example motor vehicle equipped with a vehicle power door system situated between a vehicle door and a vehicle body and which is configured to include a power-operated door presenter assembly and power-operated door check mechanism with retention function;

FIG. 1B is a partial perspective view showing a latch assembly and a power-operated door presenter assembly installed in a passenger swing door associated with the vehicle of FIG. 1A;

FIG. 1C illustrates an example embodiment of the latch assembly of FIG. 1B;

FIG. 2A is a diagrammatic view of a front passenger door shown in FIG. 1A, with various components removed for clarity purposes only, in relation to a portion of the vehicle body and which is equipped with the power door system in accordance with one aspect of the disclosure;

FIG. 2B is an inside view of the front passenger door of FIG. 2A, with various components removed for clarity purposes only, illustrating the power-operated door presenter assembly and the power-operated door check mechanism of the vehicle power door system;

FIG. 3 illustrates the power door system having a compact power-operated door presenter assembly mounted to the vehicle door, in accordance with an illustrative embodiment;

FIG. 4 is a perspective view of the power-operated door presenter assembly of FIG. 3 in accordance with an illustrative embodiment;

FIG. 5 illustrates the power door system having a power-operated door presenter assembly mounted to the vehicle body, in accordance with an illustrative embodiment;

FIGS. 6A and 6B are cross-sectional views of the power-operated door presenter assembly of the power door system shown in FIG. 5 taken along the line 6-6 of FIG. 5, illustrating the power-operated door presenter assembly in a deployed or extended state, and a retracted state, respectively;

FIGS. 7 and 8 are perspective views of the power-operated door presenter assembly of FIG. 4, having a housing cover removed to illustrate the various internal components;

FIGS. 9A and 9B are transparent perspective views of the exterior of a vehicle door and the interior of the vehicle door, respectively, illustrating the positioning of the power-operated door presenter assembly of FIG. 4 within the vehicle door, in accordance with an illustrative embodiment;

FIG. 10 is a view similar to FIG. 6A with the extensible member thereof shown in an extended state, illustrating the application of a force to return the extensible member to a retracted position;

FIG. 11 is schematic side view of a power-operated variable force door check mechanism in accordance with an illustrative embodiment;

FIG. 12 is a cross-sectional side view through a portion of a vehicle door adjacent a door pillar, with the door shown in a closed position, showing a power-operated variable force door check mechanism in accordance with an illustrative embodiment;

FIG. 12A is a cross-sectional side view through a portion of a vehicle door adjacent a door pillar, with the door shown in a partially opened presented position, showing a power-operated variable force door check mechanism in accordance with an illustrative embodiment;

FIG. 13 is a view similar to FIG. 12, with the vehicle door shown in an open position;

FIG. 14 is an illustrative example of a coordinated opening vehicle door sequence effectuated by the power-operated door check mechanism and power-operated door presenter assembly;

FIG. 15 is a method of controlling movement of a vehicle door, in accordance with an illustrative example;

FIG. 16 is a flowchart of a method of controlling movement of a vehicle door, in accordance with another illustrative example; and

FIG. 17 is a flowchart of a method executed by a controller of a power door presenter assembly to control movement of a vehicle door, in accordance with yet another illustrative example.

### DETAILED DESCRIPTION OF EXAMPLE EMBODIMENTS

In general, example embodiments of vehicle door system with power-operated door presenter assembly and power-operated door check mechanism with retention function constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

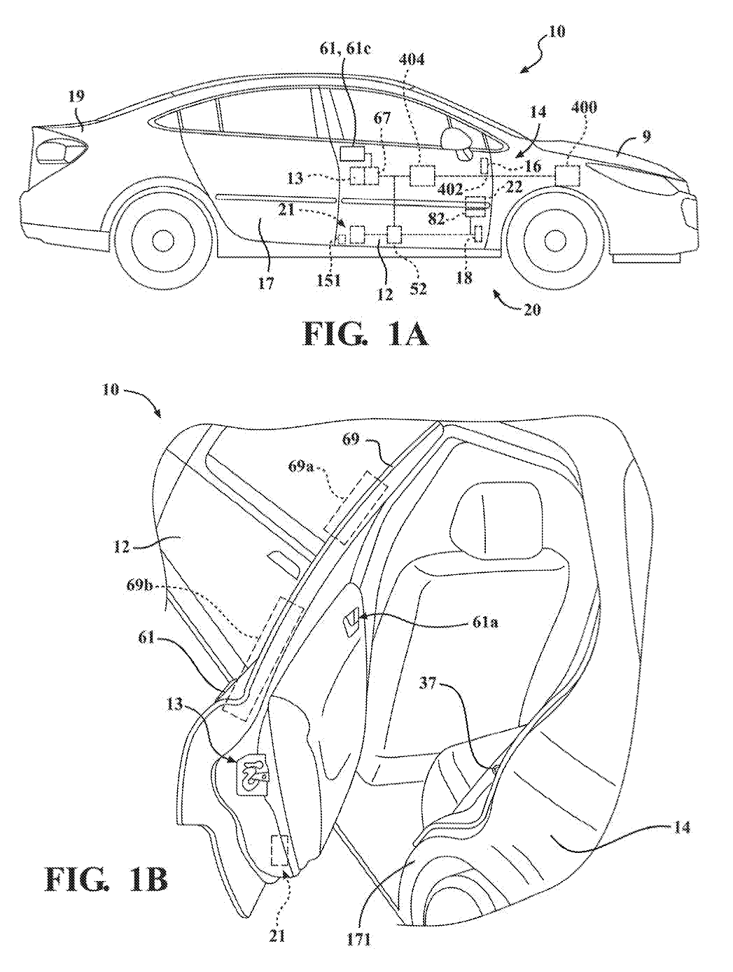

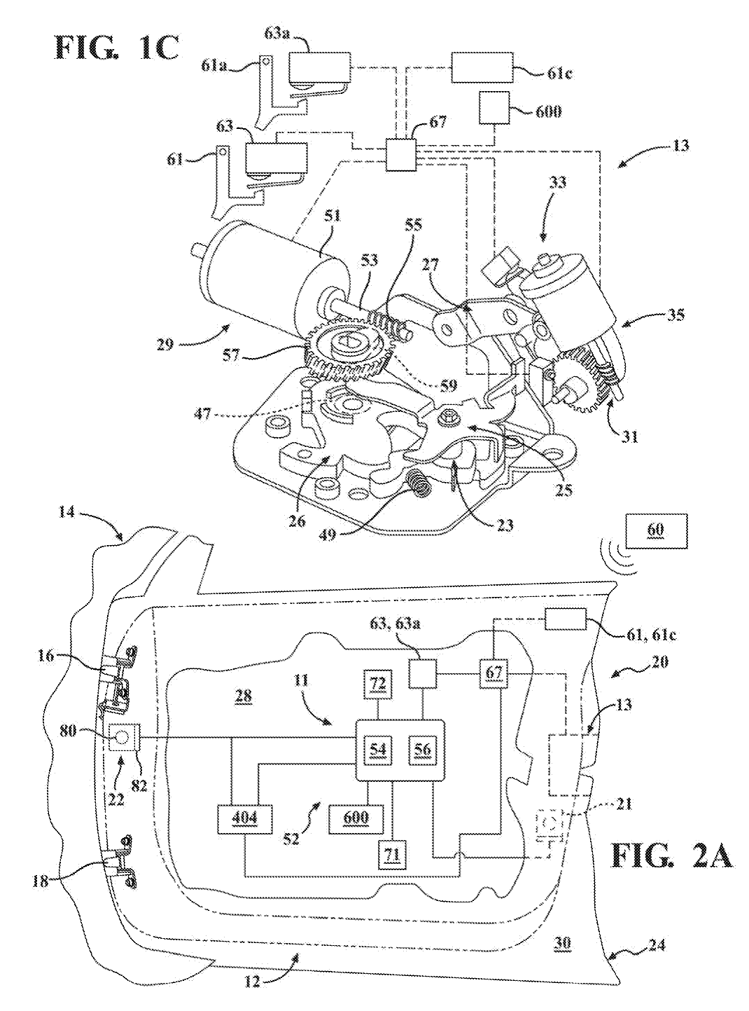

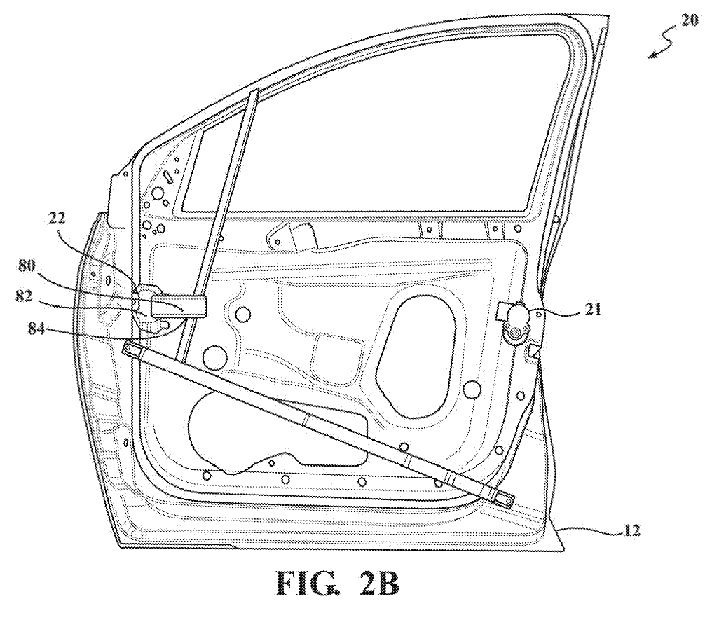

Referring initially to FIG. 1A, an example motor vehicle 10 is shown to include a first passenger vehicle door 12 pivotally mounted to a vehicle body 14 via an upper door hinge 16 and a lower door hinge 18 which are shown in phantom lines. In accordance with the present disclosure, a power vehicle door system 20 for pivoting the vehicle door 12 relative to the vehicle body 14 from a closed position to a partially open presented position and for selectively maintaining the vehicle door 12 in the presented open position is provided. Other configurations are possible, for example power vehicle door system 20 may pivot the vehicle door 12 relative to the vehicle body 14 from a closed position to a partially open position, for example at a half opened position, and for selectively maintaining the vehicle door 12 in such a partially open position. In accordance with a preferred configuration, as shown in FIG. 2B, the power vehicle door system 20 includes a power-operated door presenter assembly, referred to hereafter a power door presenter assembly 21, a swing vehicle door electronic control module (ECM) 52, a closure latch assembly 13, and a power-operated door check mechanism, referred to hereafter as power door check assembly 22. The power door check assembly 22 is provided as a separate member from the power door presenter assembly 21 to facilitate selectively maintaining the vehicle door 12 in a partially open presented position until desired by a user to move the vehicle door 12 therefrom. The term “selectively” is used herein for example as meaning that something may be intentionally and repeatedly made and unmade, for example a motor or actuator may be controlled repeatedly between powered and unpowered states; a door may be intentionally moved repeatedly between opened, partially opened, presented and closed positions. The motor vehicle 10 illustrated in FIG. 1A may be provided as not including outside vehicle door handles on the vehicle door 12, as will be understood by one possessing ordinary skill in the art upon viewing the disclosure herein, and also in an alternate embodiment, outside door handles or grasping features may be provided, an example of which is described herein below and illustrated in FIG. 1B.

Each of upper door hinge 16 and lower door hinge 18 include a door-mounting hinge component and a body-mounted hinge component that are pivotably interconnected by a hinge pin or post, as is known. While power door system 20 is only shown in FIG. 1A in association with front passenger door 12, those possessing ordinary skill in the art will recognize that the power door system 20 can also be associated with any other door of motor vehicle 10, such as rear passenger doors 17, as shown in FIG. 1B, or also be associated with a lift gate (not shown), a hood 9, or a deck lid 19, by way of example and without limitation. Also, while the vehicle door 12 is illustrated herein as being pivotally mounted to the vehicle body 14 for rotation relative to a vertical axis, it may be configured for rotation about a horizontal axis as would be the case for a lift gate, or other offset axis, oblique axis, or the like. For greater clarity, the vehicle body 14 is intended to include the ‘non-moving’ structural elements of the motor vehicle 10 such as the vehicle frame, structural support pillars and members, and body panels, as is known.

Referring to FIGS. 1B and 1C, shown is a non-limiting embodiment of a primary closure latch assembly or latch assembly, and referred to hereafter as closure latch assembly 13, for vehicle doors 12, 17 of motor vehicle 10. Closure latch assembly 13 can be positioned on vehicle door 12, 17 and arranged in a suitable orientation to engage a primary first striker, referred to hereafter as first striker 37, mounted on vehicle body 14, when vehicle door 12, 17 is closed. Closure latch assembly 13 includes a latch mechanism having a ratchet 26 and a pawl 23, a latch release mechanism having a pawl release lever 25, an inside door release mechanism having an inside release lever 27, a power release actuator 29 for controlling powered actuation of the latch release mechanism, and a power lock actuator 31 having a lock mechanism 33 and an electric lock motor 35. Ratchet 26 is movable between two striker capture positions including primary or fully closed position (shown in FIG. 1C) and secondary or partially closed position (not shown) whereat ratchet 26 retains first striker 37 against being released therefrom, and a striker release position (FIG. 1B) whereat ratchet 26 permits the free release of first striker 37 from a fishmouth provided by a latch housing of latch assembly 13. Referring to FIG. 1C, a ratchet biasing member 47, such as a spring, is provided to normally bias ratchet 26 toward its striker release position. Pawl 23 is movable between a ratchet holding position (FIG. 1C) whereat pawl 23 holds ratchet 26 in its striker capture positions, and a ratchet releasing position whereat pawl 23 permits ratchet 26 to move to its striker release position. A pawl biasing member 49, such as a suitable spring, is provided to normally bias pawl 23 toward its ratchet holding position.

Pawl release lever 25 is operatively connected to pawl 23 and is movable between a pawl release position whereat pawl release lever 25 moves pawl 23 against a bias of pawl biasing member 49 to its ratchet releasing position, and a home position whereat pawl release lever 25 permits pawl 23 to remain in its ratchet holding position under the bias of pawl biasing member 49. A release lever biasing member (not shown), such as a suitable spring, is provided to normally bias pawl release lever 25 toward its home position. Pawl release lever 25 can be moved to its pawl release position by several components, such as, for example, by power release actuator 29 and/or by inside door release lever 27. Power release actuator 29 includes an electric power release motor 51 having an output shaft 53, a power release worm gear 55 mounted on output shaft 53, and a power release gear 57. A power release cam 59 is connected for rotation with power release gear 57 and is rotatable between a pawl release range of positions and a pawl non-release range of positions. In FIG. 1C, power release cam 59 is located in a position that is within the pawl non-release range. Power release gear 57 is driven by worm gear 55 for driving cam 59 which, in turn, drives pawl release lever 25 from its home position into its pawl release position.

Power release actuator 29 can be used as part of a conventional passive keyless entry feature. When a person approaches motor vehicle 10 with an electronic key fob 60 (FIG. 2A) and actuates an outside door handle 61, for example, sensing both the presence of key fob 60 and that outside door handle 61 has been actuated (e.g. via communication between a switch 63 (FIG. 1C) and an electronic latch control unit (latch ECU) 67 (FIG. 1C) that at least partially controls the operation of closure latch assembly 13). In turn, latch ECU 67 signals and actuates power release actuator 29 to cause the latch release mechanism to release the latch mechanism and shift closure latch assembly 13 into an unlatched operating state so as to facilitate subsequent opening of vehicle door 12. Power release actuator 29 can be alternatively activated via a passive proximity sensor based entry feature (radar based proximity detection for example), for example when a person approaches motor vehicle 10 with the electronic key fob 60 (FIG. 2A) and actuates a proximity sensor 61c, such as a capacitive sensor, or other touch/touchless based sensor (based on a recognition of the proximity of an object, such as the touch/swipe/hover/gesture or a hand or finger, or the like), (e.g. via communication between the proximity sensor 61c (FIG. 1C) and latch ECU 67 (FIG. 1C) that at least partially controls the operation of closure latch assembly 13). In turn, latch ECU 67 signals and actuates power release actuator 29 to cause the latch release mechanism to release and shift closure latch assembly 13 into an unlatched operating state so as to facilitate subsequent opening of vehicle door 12.

Power door system 20 further includes power door check mechanism 22 having a housing 22′ mounted to one of the vehicle body 14 and the vehicle door 12 and shown located proximate door hinges 16, 18. Power door check mechanism 22 includes a check arm, also referred to as catch 80, and a check or catch actuator 82 for actuating movement of the catch 80 between a disengaged position and an engaged position. The catch actuator 82 is configured to maintain the catch 80 in the disengaged position when the vehicle door 12 is in the closed position and is configured to maintain the catch 80 in the engaged position when the vehicle door 12 is in the partially open presented position. If power door check mechanism 22 is mounted to the vehicle body 14, catch 80 is configured to be actuated to move into blocking or holding relation with a stop feature 84 on the vehicle door 12 while the vehicle door 12 is in the presented position, thereby selectively maintaining the vehicle door 12 in the presented position in combination with the power door presenter assembly 21, if in blocking relation with the stop feature 84, or selectively holding the vehicle door 12 in the presented position if in holding relation with the stop feature 84, discussed further below.

Referring to FIGS. 1A and 2, in accordance with preferred configurations, power door presenter system 20 generally includes power-operated door presenter assembly 21 having a housing 616 secured within an internal cavity 11 (e.g. preferably of vehicle body 14, or of a door panel structure 24 of passenger door 12, with door panel structure 24 having an outer panel 28 and an inner panel 30 defining the internal cavity 11 therebetween, for example, and therefore associated with door 12) and including an electric motor driving a drive mechanism having an extensible component. Driven rotation of the drive mechanism causes controlled translation of the extensible component which, in turn, controls pivotal movement of passenger door 12 relative to vehicle body 14. The power door presenter assembly 21 of power door system 20, as further explained below, can be located anywhere along the opening side of vehicle door 12, such as adjacent closure latch assembly 13 or below closure latch assembly 13 opposite to door hinges 16, 18. Alternatively, the housing 616 of power door presenter assembly 21 of power door system 20 can be mounted to vehicle body 14, for example at the base of the rear body pillar 151 (FIG. 1A) or sill/rocker panel 171 (FIG. 1B), which can provide increased packaging space for the presenter assembly 21. Power door system 20 provides for a partial open/close movement of vehicle door 12. As such, actuation of power door system 20 provides for coordinated and controlled presentment of vehicle door 12 via power door presenter assembly 21, such that the vehicle door 12 can be subsequently opened by the user, whereupon power door check mechanism 22 prevents unwanted, inadvertent opening of vehicle door 12 beyond the presented position until the user so desires to have the vehicle door 12 opened beyond the presented angle of inclination relative to the vehicle body, e.g., about 3 degrees, corresponding to about 30-50 mm, such as to the fully open position, as discussed in more detail hereafter.

As also shown, the electronic control module, hereinafter referred to as swing door ECM 52, is in operable communication with the catch actuator 82, such as motor 928 in accordance with an illustrative example, of power door check mechanism 22. As shown in FIG. 2A, vehicle door ECM 52 can include a microprocessor 54 and a memory 56 having executable computer readable instructions stored thereon.

FIGS. 1A, 1B, and 2A show one or more sensors 71 communicating with vehicle door ECM 52 for providing requisite information. It is recognized that sensors 71 can be any number of sensor types (e.g. Hall sensor, presence sensors such as anti-pinch strips, capacitive, ultrasonic, mechanical switches, location sensors, etc.). Such sensors may indicate to the ECM 52 that a user has a manual control of the door 12, for example a pinch strip may be provided about the door edge 69 as illustratively shown at possible handle regions 69a and 69b such that when a user grasps the handle regions 69a and 69b, pinch strip sensor 71 is activated and transmits a signal to ECM 52 indicative that a user has a grasp and has manual control of the door 12. A user may alternatively activate a mechanical switch sensor 71 provided at the handle regions 69a and 69b, or by grasping the handle regions 69a and 69b a proximity sensor such as a capacitive sensor may be activated to indicate to the ECM 52 that a user has a manual control of the door 12. Other manners of detecting a manual user control of the door 12 are possible, such as providing an absolute position sensor to detect a rotation of the hinges 16, 18, or providing an absolute position sensor to detect a movement of the elongate member 924 cause by a manual control of a user on the door 12. As is also schematically shown in FIG. 2A, swing door ECM 52 can be in communication with remote key fob 60 via a fob trans-receiver module 600 or an inside/outside handle switch 63a, 63 for receiving a request from a user to open or close vehicle door 12, including releasing power door check mechanism 22 to allow vehicle door 12 to be moved from the presented position to the fully open position. Put another way, vehicle door ECM 52 receives a command signal from either remote key fob 60 and/or inside/outside handle switch 63a, 63 to allow continued, intentional opening of vehicle door 12. It is also recognized that a body control module 72 (having memory with instructions for execution on a computer processor) mounted in vehicle body 14 of vehicle 10 can send the open request to vehicle door ECM 52 and electronic latch ECM 67.

It is recognized that other than outside handle switch 63, swing door ECM 52 can be in communication with a number of other sensors in the vehicle including, but not limited to, power door presenter assembly 21, power door check mechanism 22, and latch assembly 13. For example, the switches of latch assembly 13 can provide information to latch ECU 67 as well as swing door ECM 52 (i.e. the switches provide positional information to swing door ECM 52 of the location/state of door 12 with respect to position at or between the fully closed or latched position, secondary or partially closed and the partially open or unlatched position). Obviously a single ECM can be used to integrate the functions of swing door ECM 52 and latch ECU 67 into a common control device located anywhere within vehicle door 12.

Now referring back to FIG. 1A, the power door actuation system 20 and the closure latch assembly 13 are electrically connected to a main power source 400 of the motor vehicle 10, for example a main battery providing a battery voltage V_{batt} of 12 V, through an electrical connection element 402, for example a power cable (the main power source 400 may equally include a different source of electrical energy within the motor vehicle 10, for example an alternator). The electronic latch ECU 67 and/or vehicle door ECM 52 are also coupled to the main power source 400 of the motor vehicle 10, so as to receive the battery voltage V_{batt}; the electronic latch ECU 67 and/or vehicle door ECM 52 are thus able to check if the value of the battery voltage V_{batt} decreases below a predetermined threshold value, to promptly determine if an emergency condition (when a backup energy source may be needed) occurs.

As shown in the schematic block diagram of FIG. 1A and FIG. 2A, a backup energy source 404, which may be integrated forming part of an electronic control circuit of the electronic latch ECU 67 and/or vehicle door ECM 52, or may be separate therefrom, is configured to supply electrical energy to the power door system 20 and/or the closure latch assembly 13, and to the same electronic control circuit of the electronic latch ECU 67 and/or swing door ECM 52, in case of failure or interruption of the main power supply from the main power source 400 of the motor vehicle 10.

In an illustrative example, the backup energy source 404 includes a group of low voltage supercapacitors (not shown) as an energy supply unit (or energy tank) to provide power backup to the power door system 20 and/or the closure latch assembly 13, even in case of power failures. Supercapacitors may include electrolytic double layer capacitors, pseudocapacitors or a combination thereof. Other electronic components and interconnections of a backup energy source 404, such as a boost module to increase the voltage from the backup energy source 404 to an actuator, such as the power door system 20 for example.

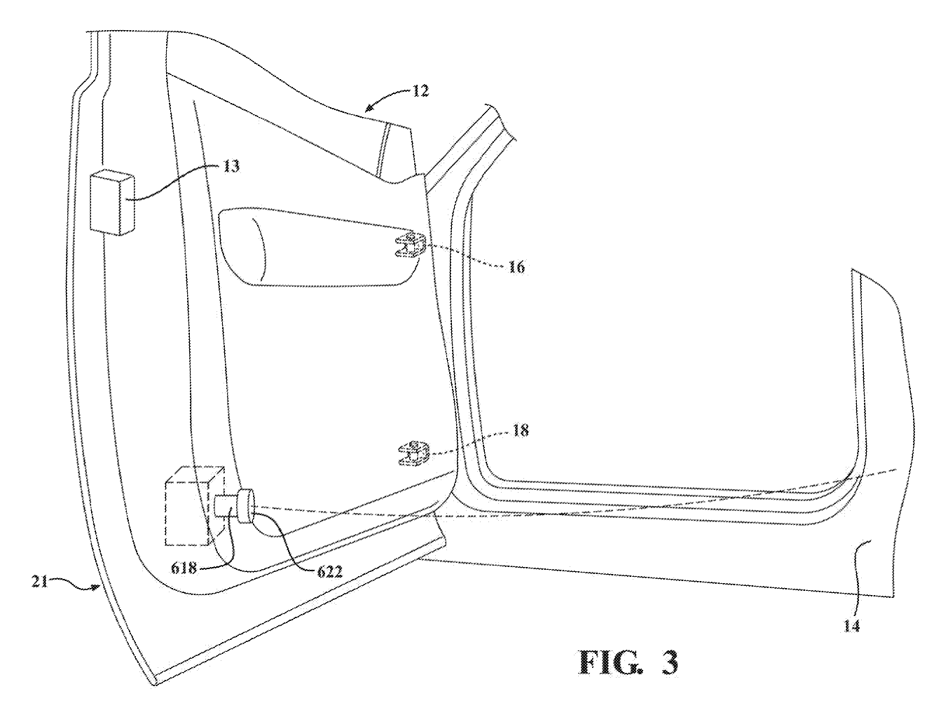

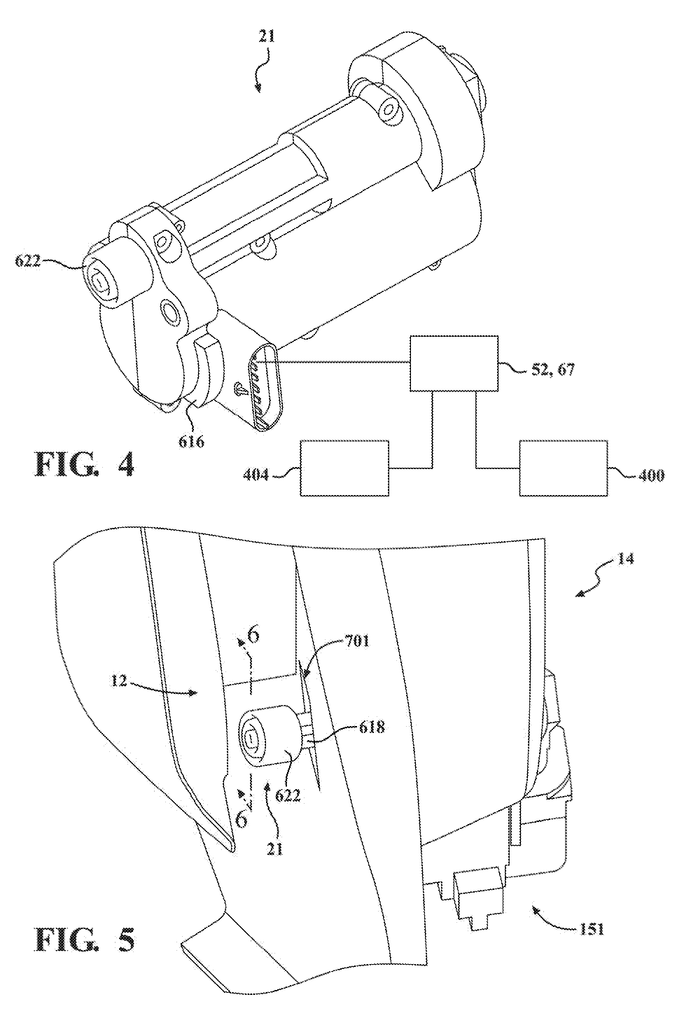

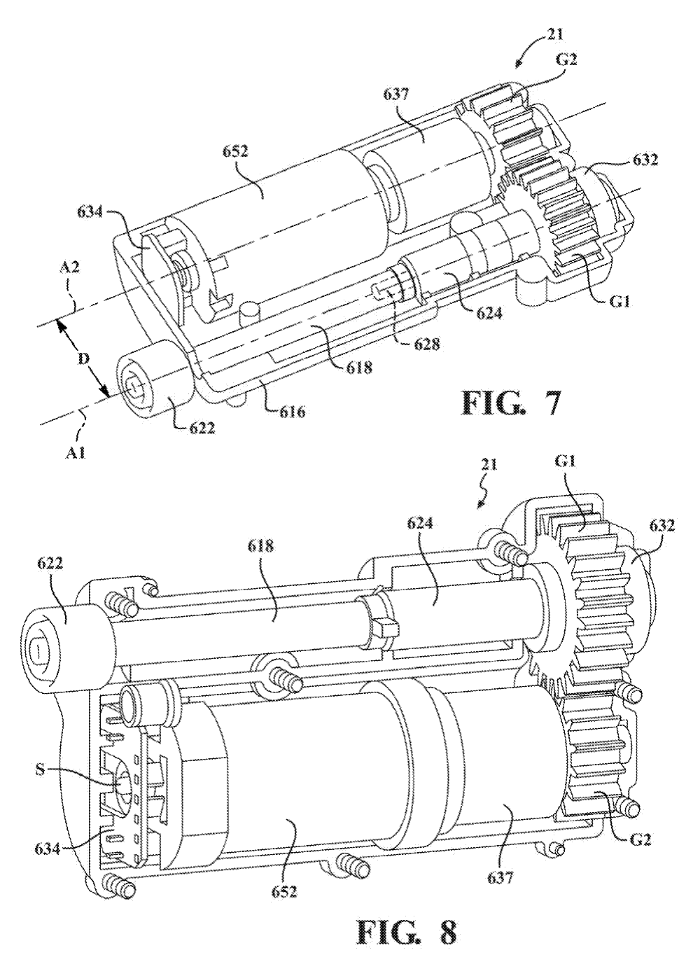

Now referring to FIGS. 3-7, in addition to FIGS. 1A and 2A, in accordance with preferred configurations, the power door presenter assembly 21 is configured for vehicle door 12 in conjunction with operation of the power door check mechanism 22, with power door presenter assembly 21 being shown secured within the internal cavity 11 (e.g. for example within or adjacent pillar 151 of vehicle body 14 as shown in FIG. 5 and therefore associated with vehicle body 14, or alternatively associated with vehicle door 12 as illustrated in FIG. 3) and including an actuator, such as an electric motor driving 652, and a drive mechanism having an extensible component 618 extendable through a port 701. Driven rotation of the drive mechanism causes controlled translation of the extensible component 618 which, in turn, controls pivotal movement of vehicle door 12 relative to vehicle body 14 as the extensible component 618 abuts against the vehicle body 14 in the exemplary configuration of the power door presenter assembly 21 being mounted to the vehicle door 12 as shown in FIG. 3, (or alternatively, the extensible component 618 abuts against the vehicle door 12 in the exemplary configuration illustrated in FIG. 5 showing the power door presenter assembly 21 mounted within the vehicle body 14). As such, it is recognized that location of the power door presenter assembly 21 between vehicle body 14 and vehicle door 12 can be at any position, as shown by example or otherwise, as desired.

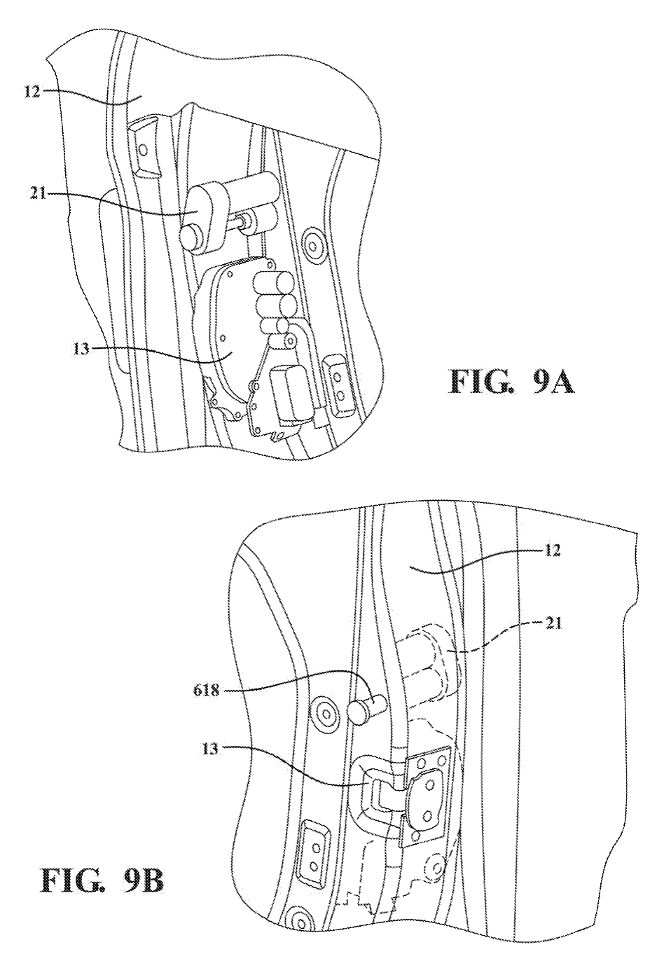

As shown in FIGS. 9A and 9B, an embodiment of power door presenter assembly 21 is positioned adjacent to a distal end of door 12 near the hem flange at a position above the latch assembly 13. Positioning the power door presenter assembly 21 opposite hinges 16, 18 provides a greater mechanical advantage for a door-moving action and allows exertion of a more effective moving force (e.g. 250 Newtons). Due to this mechanical advantage, a smaller motor 652 may be employed requiring less power to operate, and correspondingly a smaller back up energy source 404 may therefore be provided to operate the power door presenter assembly 21 to present the vehicle door 12 in the event of a power failure of the main power source 400. Further, due to this increase in mechanical advantage, the power door presenter assembly 21 can provide ice breaking functionality as well as assist with the movement of the vehicle door 12 in a post-crash condition, where for example the vehicle door 12 may be damaged and thus seized or jammed relative to the vehicle body 14 and thus requiring a greater than normal opening force to overcome this state.

While the vehicle door 12 can be employed as part of a door system including an outside door handle 61, the power door system 20 can be employed for coordinated and controlled presentment of vehicle door 12 to a user requesting opening of the vehicle door 12 in the configuration of the vehicle door 12 without a door handle, for example having a proximity sensor 61c in lieu of an outside door handle 61. In such a configuration, the presentment of vehicle door 12 would be sufficient to move the vehicle door 12 away from the vehicle body 14 so that the fingers of the user exterior the vehicle 14 can be slipped between the vehicle body 14 and the vehicle door 12 to grasp, for example about door edge 69 as illustratively shown at possible handle regions 69a and 69b in FIG. 1B, and to subsequently pull the vehicle door 12 to open it. The power door presenter assembly 21 can also be employed for coordinated and controlled presentment of door 12 to a user requesting opening of the vehicle door 12 using inside door handle 61a. In all configurations, the presentment of vehicle door 12 may be sufficient to move the vehicle door 12 away from the vehicle body 14 to break through any ice build-up on vehicle door 12 and vehicle body 14 tending to prevent a vehicle door 12 from easily opening i.e. acting as an ice breaker function.

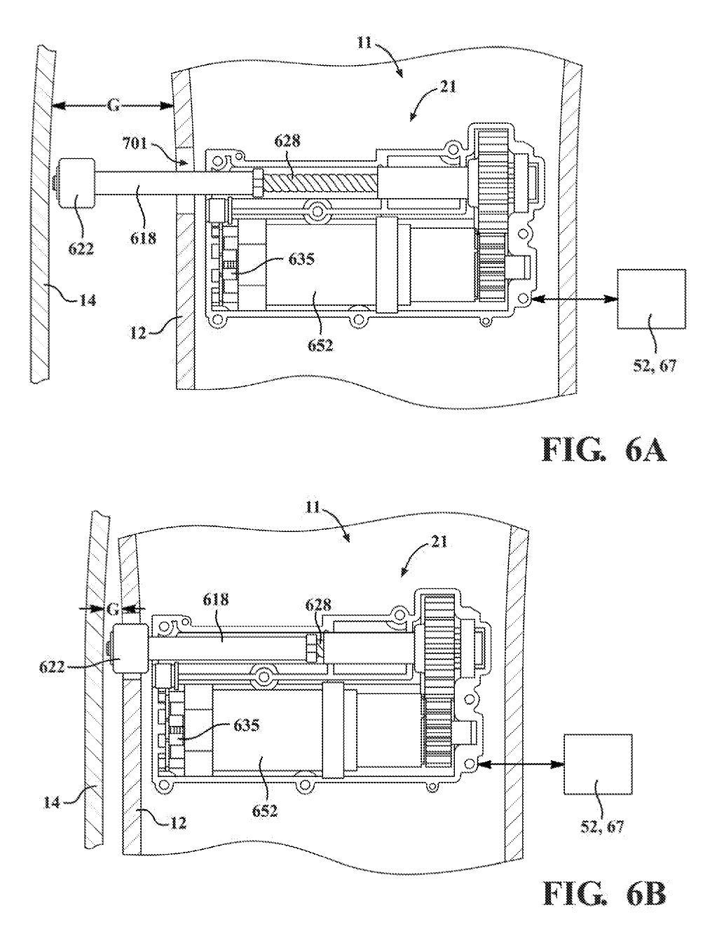

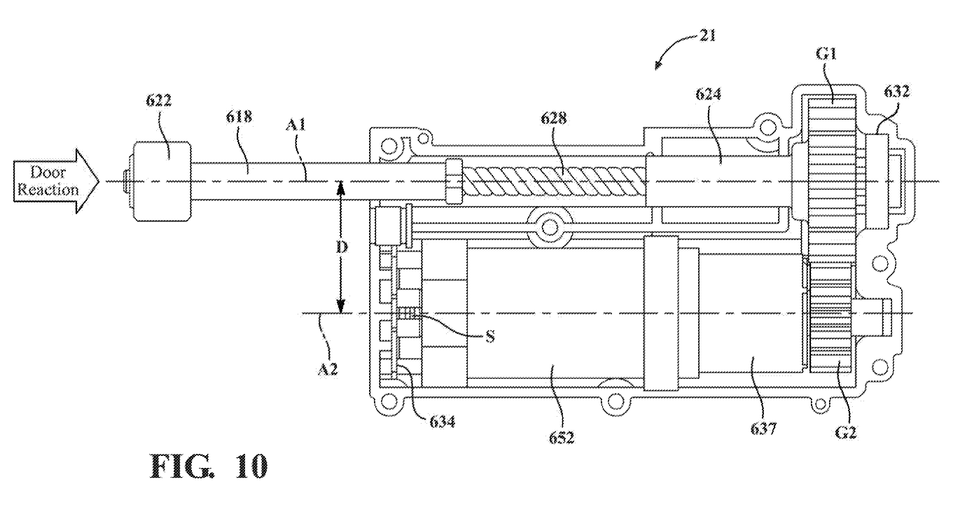

A non-limiting embodiment of power door system 20 will now be described with reference to FIGS. 3 through 10 to generally include a power door presenter assembly 21. In general, power door presenter assembly 21 is adapted to be rigidly secured to vehicle body 14 or the vehicle door 12, such as by securing housing 616 encapsulating the various components of the power presenter assembly 21. In an alternative embodiment, power door presenter assembly 21 may be a power-operated swing door actuator such as discussed in co-owned U.S. patent application Ser. No. 15/674,988, filed Aug. 11, 2017 and published Feb. 22, 2018 as US 2018/0051502 A1, which is incorporated herein by way of reference in its entirety and which may be configured to move the door 12 described herein to a presented position, and may be further employed thereafter for a door system with a power assisted door opening mode in addition to a manual user controlled operation as described herein. The housing 616 defines a cylindrical chamber in which the extensible member 618 slides. The extensible member 618 can be configured having an external distal end as discussed above, and is shown, by way of example and without limitation, as having a bumper, such as an elastic bumper 622 for abutment with the vehicle body 14. The power door presenter assembly 21 further includes an internally threaded cylindrical tube 624 which is rotatably connected to a lead screw 628 connected to a proximal end of the extensible member 618. The lead screw 628 is threadingly matable with the internally threaded cylindrical tube 624, also referred to as nut tube or nut 624, to permit relative rotation and translation between lead screw 628 and the nut tube 624. The extensible member 618 is non-rotatably and axially moveable on leadscrew 618 between a retracted position (FIGS. 6B and 8) and an extended position (FIGS. 6A and 10) relative to housing 616. When extensible member 618 is located in its extended position (FIGS. 6A and 10), vehicle door 12 is urged into the partially opened presented position. The configuration of the lead screw 628 and nut 624 i.e. the thread pitch angles and geartrain unit are such so as to provide a manual reversibility of extensible member 618 from the deployed position to its retracted position, for example by urging the extensible member 618 toward its retracted position by a closing of the vehicle door 12 abutting the elastic bumper 622.

In the embodiment shown in FIGS. 8 and 10, because the nut tube 624 is fixedly attached to a driven gear G1 for rotation in the housing 616 but is prevented from linear translation, as the driven gear G1 rotates in meshed engagement with a drive gear G2 in response to selective actuation of the motor 652, the nut tube 624 rotates, thereby causing the lead screw 628 and extensible member 618 fixed thereto to translate linearly along a first axis A1, causing the extensible member 618 to move with respect to the housing 616. Since the extensible member 618 is configured in this illustrated embodiment for abutment with the vehicle body 14 and the housing 616 is connected to the vehicle door 12, movement of the extensible member 618 causes the vehicle door 12 to pivot relative to the vehicle body 14. The lead screw 628 and the nut tube 624 thereby define a spindle-type rotary-to-linear conversion mechanism.

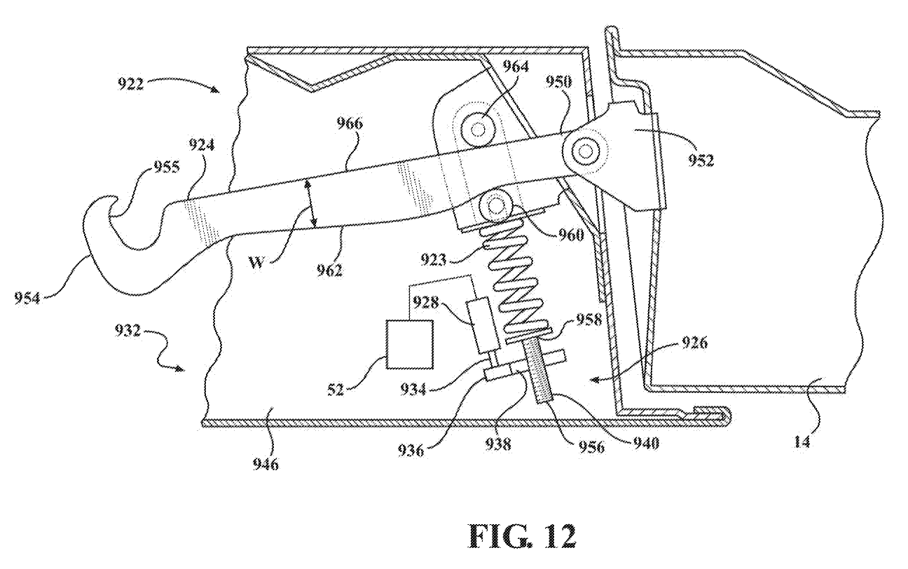

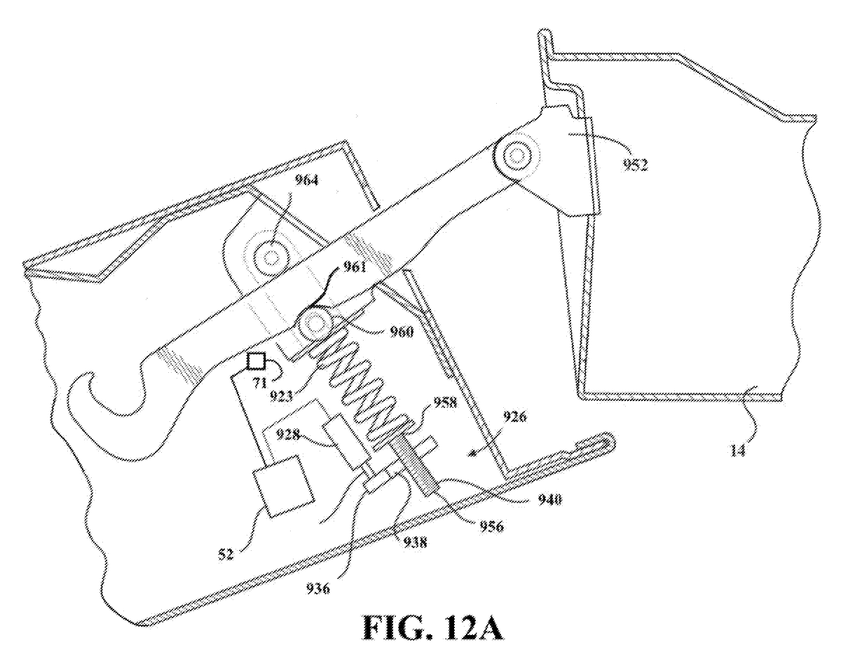

The lead screw 628 is rotatably connected to the nut tube 624 that is journaled in the housing 616 via any suitable bearing 632 that provides radial and linear support for the nut tube 624. A PCB 634 with sensor, such as a Hall-effect sensor 635, by way of example and without limitation, is mounted about a shaft S of the motor 652. The sensor 635 can detect motor shaft rotations and convert detected rotations into an absolute linear position electrical signal so that the linear position of the extensible member 618 is relatively known. In alternative embodiments, the sensor 635 can be provided as discussed above, such by a linear encoder which reads the travel between components that move relative to one another, so that the linear position of the extensible member 618 is known with certainty, even upon power up. With reference now to FIG. 6A, in accordance with an illustrative embodiment, a controller 639 may be provided on PCB 634, the controller 639 in electrical communication with door ECM 52, and in electrical communication with power door check assembly 22. Controller 639, which may include a memory and a microprocessor for executing software instructions stored in the memory and may be configured to receive a presentment command signal from door ECM 52, for example in response to a door open command signal being received by door EMC 52 from door handle 61 or FOB 60. Controller 635 may be configured to detect a signal from a position sensor 637 positioned adjacent the extensible member 618 as shown in FIG. 6A to detect the extensible member 618 reaching an extended position to move the door 12 to a presented position. In response to detecting that the extensible member 618 is in the extended position as shown in FIG. 6A corresponding to door 12 being in a presented position as shown in FIG. 12A, controller 639 may transmit a control signal, such as a power signal in the form of voltage and/or current for directly actuating a motor, or a communication control signal such as in the form of an electrical communication message, to door check mechanism 22, such as power-operated variable force door check mechanism 922, to control actuation of the adjuster 926 to move roller 960 into detent or notch 961 provided on one side 962 of the check arm 924 corresponding to the presented position of 50 mm for example to assist with the power door check mechanism 22, 922 to maintain the door 12 in the presented position by maintaining door check mechanism in the engaged state. Now referring to FIG. 17, there is illustrated a method of controlling the power door presenter assembly 4000 provided as a flowchart of software instructions stored in memory and executed by controller 639, including the steps of receiving, by the power door presenter assembly 21, a door opening command signal 4002, actuating an electric motor of the power presenter assembly to move an extensible member and cause the vehicle door to move from the closed position to the partially opened position, such as the presented position 4004, sensing the extensible member in the fully extended position corresponding to door 12 in the partially opened position 4006, and controlling, such as by transmitting a control signal to, the door check mechanism to shift the door check mechanism from a disengaged state to an engaged state to hold the door in the partially opened position 4008. Controller 635 may receive a user manual control signal from sensor 71 and transmit a control signal to the door check mechanism to shift the door check mechanism from the engaged state to a disengaged state to allow the door to move from the partially opened position under manual control by a user for example.

The motor shaft S is connected to a geartrain unit, also referred to as planetary gear box 637. The gear box 637 may be operably connected to a clutch unit that is normally engaged and can be energized to disengage to facilitate reversal of door presenter assembly. Further discussion here with regard to the clutch unit, given the discussion above, is believed unnecessary.

The motor 652 and the extensible member 618 are packaged within the housing 616 to provide a compact assembly having a minimal outer envelope, and in particular a minimized length (when compared to a configuration having the extensible member 618 and the motor 652 in a series arrangement having their longitudinal axes aligned), thereby requiring reduced space in which to mount the power door presenter assembly 21. For example, in mounting positions in the vehicle door 12, the width of the door 12 can be correspondingly reduced due to the compact length of the power door presenter assembly 21 (e.g. approximately half when compared to a series arrangement). To provide the minimal outer envelope of the housing 616, the motor shaft S is oriented to extend along a second axis A2 that is parallel or substantially parallel (meaning that the axes A1, A2 may be slightly off parallel, such as by a few degrees) with one another. Further, the motor 652 and extensible member 618 are immediately adjacent one another in laterally aligned and spaced relation by a distance D equal to the sum of the radii of the driven gear G1 and drive gear G2.

Upon receiving a present command, vehicle door ECM 52 can provide a signal to electric motor 652 in the form of a pulse width modulated voltage (for speed control) to turn on motor 652 and initiate pivotal opening movement of vehicle door 12 towards its partially open deployed position (i.e. presented position) (recognizing that primary latch assembly 13 is already in its unlatched state as further discussed below) via extension of extensible member 618. While providing the signal, swing door ECM 52 can also obtain feedback from sensors 64, 71 to ensure that contact with an obstacle has not occurred or occurring as would be the case if an object or person is leaning upon the vehicle door 12 or otherwise that the user is present (e.g. is manually in charge of door 12). If no obstacle is present, motor 652 will continue to generate a rotational force to actuate spindle drive mechanism and thus extension of extensible member 618 until certain door positions are reached (e.g. 30-50 mm presented position) or otherwise indicate that the user is present (e.g. hand is on the presented door 12 at the handle regions 69a and 69b for example). Once vehicle door 12 is positioned at the desired presented position, motor 652 is turned off. In simultaneous actuation of the power door presenter assembly 21 or upon reaching the vehicle door 12 reaching the fully presented position, the catch actuator 82 of the power door check mechanism 22 is signaled to move the catch 80 from its disengaged position to its engaged position with the stop feature 84 to maintain the vehicle door 12 in its presented position until desired otherwise.

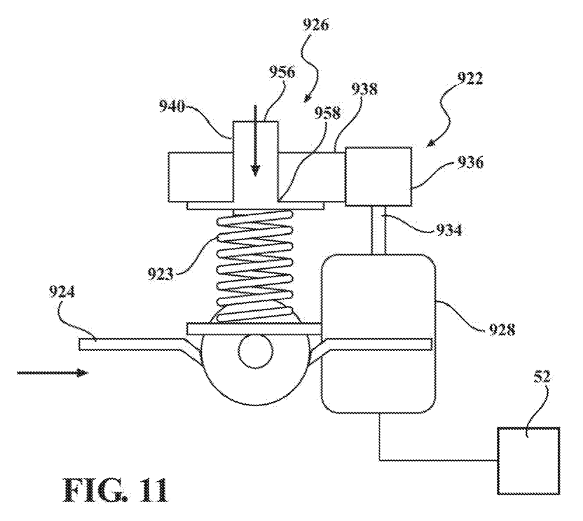

Now referring to FIGS. 11 to 13, an exemplary power-operated variable force door check mechanism 922, such as discussed in co-owned U.S. patent application Ser. No. 16/159,782, filed Oct. 15, 2018, which is incorporated herein by way of reference in its entirety, and referred to hereafter simply as mechanism 922, also shown in part in phantom lines as reference 22 in FIG. 1A and generally at 22 in FIGS. 2A and 2B, is integrated for operable communication with the pivotal connection between front passenger door 12 and a vehicle body 14. In accordance with a illustrative configuration, the mechanism 922 generally includes a continuously variable force application member 923 configured to selectively vary the force, in non-linear fashion, applied to an elongate member 924, also referred to as check arm, while the vehicle door 12 is being pivoted between opened and closed positions. The continuously variable force application member 923 is configured in communication with a check actuator, also referred to as adjuster 926, wherein the adjuster 926 is configured in operable communication, via an intervening check actuator motor, referred to hereafter as motor 928, with an electronic control module (ECM) 52 to selectively adjust the force applied to the check arm 924 by the continuously variable force application member 923. The ECM 52 may be provided as part of the main vehicle electronic control unit (ECU), and/or from a separate control unit, such as an ECU in a vehicle door latch assembly, by way of example and without limitation.

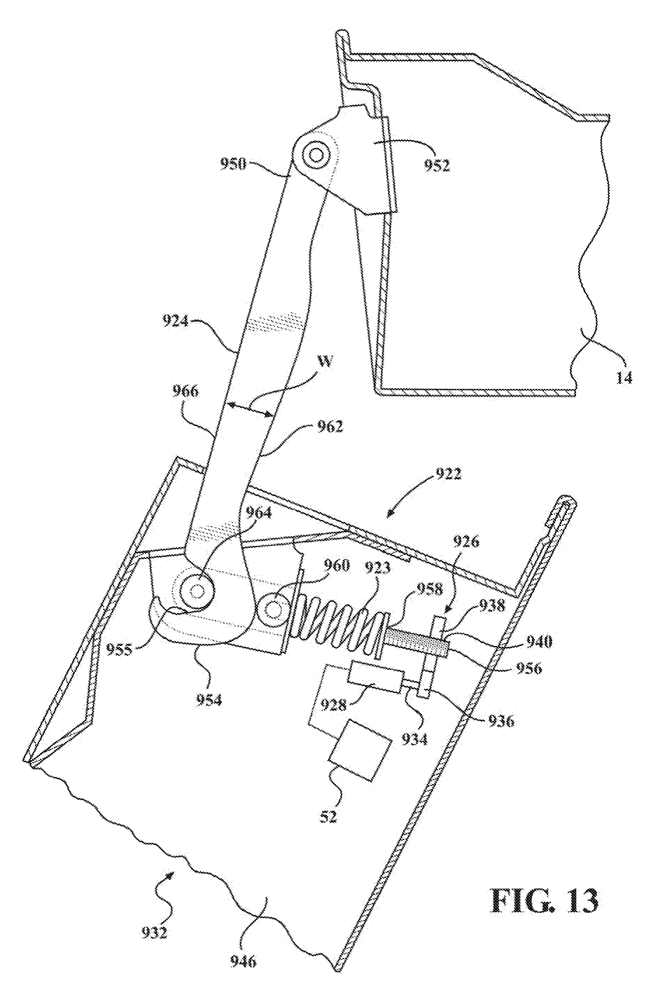

The mechanism 922 is secured, at least in part, within an internal cavity 932 (FIGS. 12-13) of passenger door 12. The motor 928 can be provided as an electric motor 928, by way of example and without limitation, and can be configured to drive a rotary driven member, such as a shaft 934 having a drive member, such as a gear member 936, in a non-limiting embodiment, connected thereto for rotation in response to selective actuation of the motor 928. The gear member 936 is arranged in driving communication with the adjuster 926, and in one non-limiting embodiment, the adjuster 926 can be provided as a linear actuator including a drive nut 938 configured for engagement with a driven member, such as a threaded screw 940, such that rotation of the drive nut 938 causes linear translation of the screw 940, which in turn results in varying the force applied by the continuously variable force application member 923 on the check arm 924. As such, the resistance to pivoting movement of the door 12 fostered by the force of the adjuster 926 applied on the check arm 924 can be continuously varied, as desired, via selective actuation of the motor 928, as discussed in more detail hereafter. The force can be such so as to “check” or hold the door 12 at a desired position in coordination with the door presenter 21 as described in more detail herein below. It is to be recognized that the adjuster 926 may include other than a linear actuator, such as a solenoid actuator or otherwise, such as will be recognized and understood by one skilled in the art upon viewing the present disclosure. While the mechanism 922 is only illustrated in association with front passenger door 12, those skilled in the art will recognize and understand that the mechanism 922 can also be associated with any other door or liftgate of vehicle 10 such as, by way of example and without limitation, the rear passenger doors 17 and deck lid 19.

The swing door 12 includes inner and outer sheet metal panels 946 and 948 defining the internal cavity 932. The mechanism 922 may be mounted within the internal cavity 932, as noted above. A first terminal end, also referred to as proximal end 950, of check arm 924 is shown pivotally mounted to the vehicle body 14, such as to an A-pillar and/or B-pillar via a mount bracket 952, by way of example and without limitation, wherein the check arm 924 extends generally horizontally to a second terminal end, also referred to as distal end 954. The check arm 924 is shown as having a varying width (W) along its length and a generally hook-shaped pocket 955 that serves as a stop feature to prevent the door 12 from being opened beyond a predetermined position. Upon viewing the entirety of the disclosure herein, one skilled in the art will recognize that the shape of the check arm 924 can be modified as desired, including having a constant width W, if desired, as the width W of the check arm 924 is not required to change to affect the opening and closing operation of the door 12, due to the ability of the mechanism 922 to vary the force applied to the check arm 924 via adjuster 926, thereby simplifying construction and reducing the cost associated with the check arm 924.

The mechanism 922 is configured for incorporation into an existing door structure without need for modification, though the check arm 924 in the existing door could be changed, if desired. The adjuster 926 (drive nut 938 and screw 940), motor 928 (with shaft 934 and drive member 936), can all be mounted and supported within the internal cavity 932 of the door 12, such as via attachment to the inner panel 946, by way of example and without limitation.

The drive nut 938 can be provided being fixed against axial movement for rotation in response to driven rotation of the drive member 936. As such, the drive member 936 can be provided as a gear in meshed engagement with an outer surface of the drive nut 938, by way of example and without limitation. It is contemplated herein that mechanisms of engagement between the drive member 936 and drive nut 938 could be utilized other than meshed teeth, such as any suitable high frictional engagement therebetween, such as a rubberized surface or the like, sufficient to cause conjoint rotation in response to the motor 928 driving the drive member 936. The drive nut 938 has a threaded through bore sized for receipt of the screw 940 therethrough, wherein the drive nut 938 and screw 940 can be provided as a lead screw assembly with corresponding mating threads, or they can be provided as a ball screw assembly having balls received in aligned internal and external helical grooves, if desired, as will be readily understood by one possessing ordinary skill in the art. Accordingly, with the drive nut 938 being fixed against translation, the screw 940 translates back and forth, toward and away from the continuously variable force application member 922, in response to a selectively actuated rotation of the drive nut 938 in clockwise and counterclockwise directions.

The screw 940 has a free proximal or first end 956 and an opposite distal or second end 958. The second end 958 is located for operable engagement with the continuously variable force application member 923, such as a coil spring member 923, by way of example and without limitation. As such, as the screw 940 is translated toward the spring member 923, the second end 958 causes the spring member 923 to be compressed, thereby increasing the force of the spring member 923 acting operably (directly or indirectly via an intermediate member) on the check arm 924. As shown in a non-limiting embodiment of FIGS. 12 and 13, the spring member 923 can be configured to act on a first roller 960 or shaft thereof to bias the first roller 960 into engagement with one side 962 of the check arm 924 to move, or shift, the check arm 924 into an engaged state to prevent the check arm 924 from moving relative to the roller 960 otherwise below a threshold of force applied to the check arm 924 for example by a user having manual control of the door 12, while a second roller 964 can be fixed for rolling engagement with an opposite side 966 of the check arm 924 to capture the check arm 924 for translation between the rollers 960, 964, to shift the check arm 924 into an engaged state for example. It is to be recognized that the force with which the first roller 960 engages the side 962 of check arm 924 increases and decreases, respectively, as the spring member 923 is axially compressed and expanded. Accordingly, as the spring member 923 is axially compressed, the resistance to translation of the check arm 924 between the rollers 960, 964 is increased, and as the spring member 922 is axially expanded, the resistance to translation of the check arm 924 between the rollers 960, 964 is decreased. It is to be further recognized that the use of rollers is non-limiting, and that a suitable low-friction member(s), such as a skid plate(s) or the like, could be incorporated, such a member(s) of PTFE, or other suitable lubricious material.

With the vehicle door 12 being brought to the presented position and upon the power door check mechanism 22, 922 having been moved to its engaged position, the user may then take control of vehicle door 12, whereupon a signal from one of the aforementioned sensors to the ECM 52 that the vehicle door 12 is under manual control by the user, the extensible member 618 may be retracted by a signal from door ECM 52 actuating the motor 652 in the reverse direction. In the case of a power failure, the extensible member 618 may be easily retracted manually by the user simply manually closing the vehicle door 12 to urge the extensible member 618 to its retracted position.

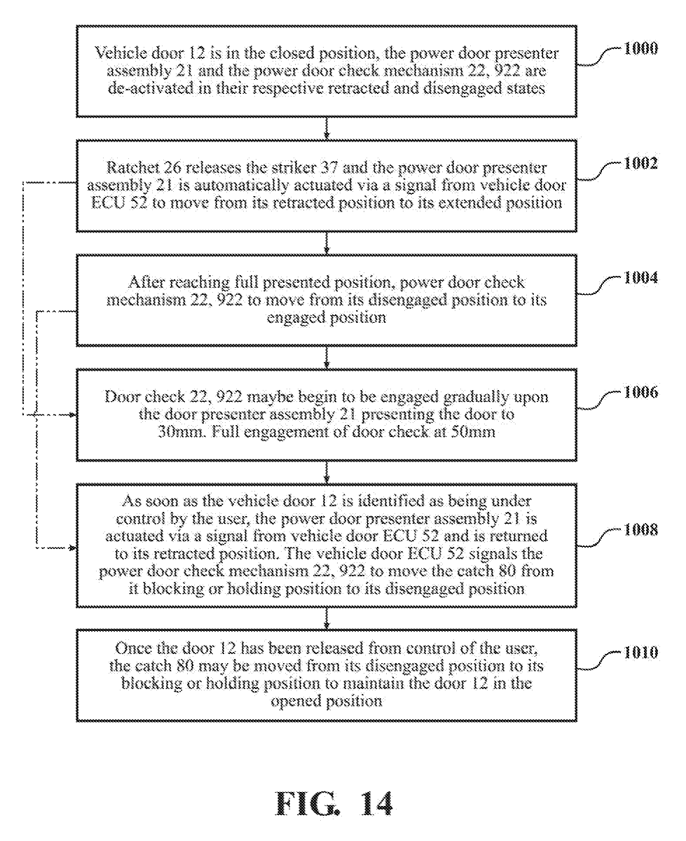

Now referring to FIG. 14, an illustrative sequence of operation of the power door system 20, 920 and door presenter assembly 21 thereof operated in a coordinated manner with the door check 22, 922 thereof is described. At step 1000, when the vehicle door 12 is in the closed position, the power door presenter assembly 21 and the power door check mechanism 22, 922 are de-activated in their respective retracted and disengaged states. Then at step 1002, when the closure latch assembly 13 receives a command to move to its unlatched state, such as via latch ECU 67 or otherwise, the ratchet 26 releases the striker 37 and the power door presenter assembly 21 is automatically actuated via a signal from vehicle door ECM 52 to move from its retracted position to its extended position, thereby bringing the vehicle door 12 to the presented position. At step 1004, upon or simultaneously with the signal from the vehicle door ECM 52 to the power door presenter assembly 21, the vehicle door ECM 52 also signals the power door check mechanism 22, 922 to move from its disengaged position to its engaged position, thereby bringing catch 80, such as check arm 924 in accordance with an illustrative example, into blocking abutment or holding relation with the stop feature 84. For example, the door presenter assembly 21 may move the door 12 to the fully presented position of 50 mm. At 50 mm the door check 22 may be engaged. For example and with reference to FIG. 12A, when door check 22 is engaged, first roller 960 may be configured to engage, for example by actuation of the adjuster 926, a detent or notch 961 provided on one side 962 of the check arm 924 corresponding to the presented position of 50 mm for example to assist with the power door check mechanism 22, 922 to maintain the door 12 in the presented position. Alternatively, at step 1006 the door check 922 may begin to be engaged gradually upon the door presenter assembly 21 presenting the door 12 to 30 mm, or after a predetermined period of time from the commencement of the door presentment, as discussed above, wherein a gradual increase of resistance can be applied to the check arm 924 by the door check 922 between 30 and 50 mm of the door check 922 such that over presentment of the door 12 is avoided, for example if the vehicle 10 is on a slope the door 12 may be presented to 70 mm due to the force of gravity acting on the door 12 rather than the presenter assembly 21 moving the door 12. Accordingly, with the catch 80 in blocking abutment (unidirectional blocking in combination with the extended power door presenter assembly 21) or holding relation (bidirectional holding) with the stop feature 84, or with the force of the adjuster 926 applied on the check arm 924 being suitably varied, the vehicle door 12 is releasably maintained in the presented position until it is desired to move the vehicle door 12 therefrom, such as to a fully open or closed position. As such, while the vehicle door 12 is being maintained in the presented position via the catch 80 or via the force of the adjuster 926 applied on the check arm 924, not only is the vehicle door 12 secured against inadvertent opening under the force of gravity or wind, thereby avoiding the vehicle door 12 from being swung wildly open into an object or approaching user, but also allows the user to comfortably grasp the door edge 69 or other grasping feature to open the vehicle door 12 from the presented position to the fully open position without concern of the vehicle door 12 being inadvertently closed on the user's fingers. At step 1008, as soon as the vehicle door 12 is identified as being under control by the user, such as via a sensed signal that the user's hand is on the vehicle door 12, the power door presenter assembly 21 is actuated via a signal from vehicle door ECM 52 and is returned to its retracted position. Simultaneous with the signaling from the vehicle door ECM 52 to the power door presenter assembly 21, the vehicle door ECM 52 signals the power door check mechanism 22, 922 to move the catch 80 from it blocking or holding position to its disengaged position or the force of the adjuster 926 applied on the check arm 924 to be reduced, whereupon it remains until the process is repeated, such that the user may freely choose to open or close the vehicle door 12. Optionally at step 1010, once the door 12 has been released from control of the user, the catch 80 or adjuster 926 may be moved from its from its disengaged position to its blocking or holding position to maintain the door 12 in the opened positioned (fully or an intermediate position when release of control of the door 12 by the user is detected) to prevent the door 12 from being swung wildly open into an object or approaching user due to wind or other influence. Otherwise, it is contemplated herein that the power door system 20, 920 can be configured to allow the vehicle door 12, upon being moved to its presented position, to be returned to the closed position only after the vehicle door 12 is moved toward the open direction from the presented position, thereby assuring the vehicle door 12 is not inadvertently closed upon being moved to the presented position. In this case, the power door check mechanism 22, 922 can be configured to indicate to the power door presenter assembly 21, via the vehicle door ECM 52, when the vehicle door 12 has been moved beyond the presented position, thereby allowing the vehicle ECM 52 to signal the power door presenter assembly 21 to return to its retracted position.

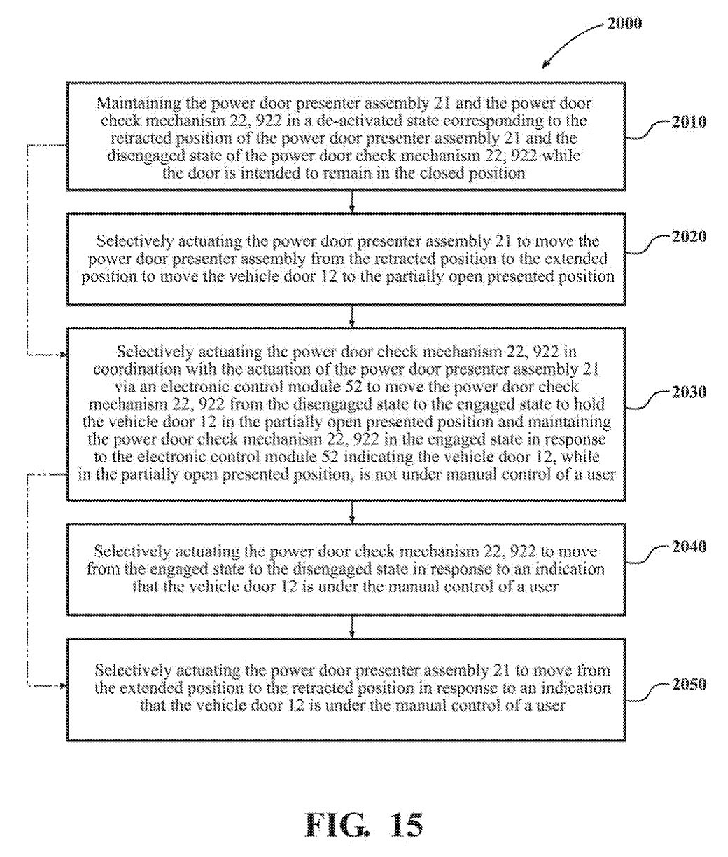

Now referring to FIG. 15, a method 2000 of controlling movement of a vehicle door 12 between a closed position, a partially open presented position, and an open position relative to a vehicle body 14 with a power door presenter assembly 21 configured to selectively move from a retracted position, corresponding to the vehicle door 12 closed position, to an extended position, corresponding to the partially open presented position, and a power door check mechanism 22, 922 configured to move from a disengaged state to release the vehicle door 12 to an engaged state to selectively hold the vehicle door 12 in the partially open presented position is illustrated. The method includes a step 2010 of maintaining the power door presenter assembly 21 and the power door check mechanism 22, 922 in a de-activated state corresponding to the retracted position of the power door presenter assembly 21 and the disengaged state of the power door check mechanism 22, 922 while the door is intended to remain in the closed position. Further, at step 2020 selectively actuating the power door presenter assembly 21 to move the power door presenter assembly from the retracted position to the extended position to move the vehicle door 12 to the partially open presented position. Then, at step 2030 selectively actuating the power door check mechanism 22, 922 in coordination with the actuation of the power door presenter assembly 21 to move the power door check mechanism 22, 922 from the disengaged state to the engaged state to hold the vehicle door 12 in the partially open presented position, thereby preventing the vehicle door 12 from inadvertently opening to a fully open state or returning to the closed state, such as under the power of wind or gravity.

The method can further include at step 2040 selectively actuating the power door check mechanism 22, 922 to move from the engaged state to the disengaged state in response to an indication that the vehicle door 12 is under the manual control of a user.

The method can further include at step 2050 selectively actuating the power door presenter assembly 21 to move from the extended position to the retracted position in response to an indication that the vehicle door 12 is under the manual control of a user.

The method can further include within step 2030 configuring the power door presenter assembly 21 and the power door check mechanism 22, 922 in operable communication with an electronic control module 52 and coordinating actuation of the power door presenter assembly 21 and the power door check mechanism 22, 922 via signals from the electronic control module 52.

The method can further include within step 2030 maintaining the power door check mechanism 22, 922 in the engaged state in response to the electronic control module 52 indicating the vehicle door 12, while in the partially open presented position, is not under manual control of a user.

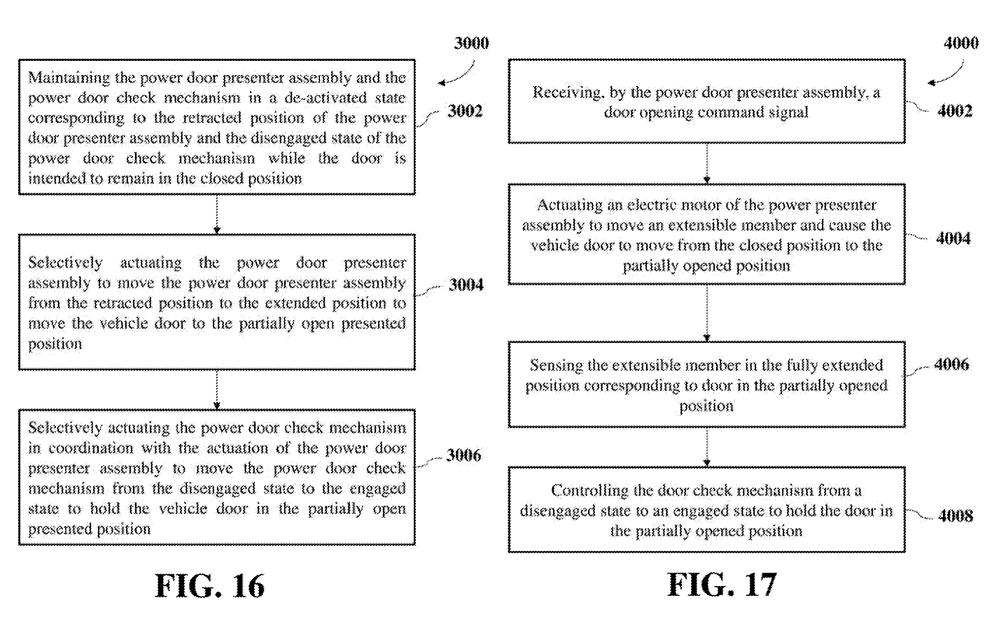

Now referring to FIG. 16, there is provided a method 3000 of controlling movement of a vehicle door between a closed position, a partially open position, and an open position relative to a vehicle body with a power door presenter assembly configured to selectively move the vehicle door from a closed position to a partially open position, and a power door check mechanism configured to move from a disengaged state to release the vehicle door to an engaged state to selectively hold the vehicle door in the partially open position. The method illustratively includes the steps of maintaining the power door presenter assembly and the power door check mechanism in a de-activated state corresponding to the retracted position of the power door presenter assembly and the disengaged state of the power door check mechanism while the door is intended to remain in the closed position 3002, selectively actuating the power door presenter assembly to move the power door presenter assembly from the retracted position to the extended position to move the vehicle door to the partially open position 3004; and selectively actuating the power door check mechanism in coordination with the actuation of the power door presenter assembly to move the power door check mechanism from the disengaged state to the engaged state to hold the vehicle door in the partially open presented position 3006.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power vehicle door system for pivoting a vehicle door relative to a vehicle body from a closed position to a partially open presented position and for selectively maintaining the vehicle door in the partially open presented position, comprising:
a power presenter assembly mounted to one of the vehicle body and the vehicle door and having an extensible member and a presenter actuator for actuating movement of the extensible member between a retracted position corresponding to the closed position of the vehicle door and an extended position corresponding to the partially open presented position of the vehicle door; and
a power door check mechanism separate from the power presenter assembly, the power door check mechanism being mounted to one of the vehicle body and the vehicle door and having a check arm and a check actuator configured to move the check arm between a disengaged state and an engaged state, the check actuator being configured to maintain the check arm in the disengaged state when the vehicle door is in the closed position and the check actuator being configured to maintain the check arm in the engaged state when the vehicle door is in the partially open presented position.

2. The power vehicle door system of claim 1, wherein the check actuator is configured to move the check arm from the engaged state to the disengaged state in response to an indication the vehicle door is under manual control of a user.

3. The power vehicle door system of claim 2, wherein the presenter actuator is configured to move the extensible member from the extended position to the retracted position in response to an indication the vehicle door is under manual control of a user.

4. The power vehicle door system of claim 2, wherein the check actuator is configured to maintain the check arm in the engaged state in response to an indication the vehicle door is not under manual control of a user while in the partially open presented position.

5. The power vehicle door system of claim 2, wherein the power door check mechanism includes a continuously variable force application member configured to selectively vary the force applied to the check arm while the vehicle door is being pivoted between opened and closed positions.

6. The power vehicle door system of claim 4, wherein the presenter actuator is configured to maintain the extensible member in the extended position when the vehicle door is indicated as not being under manual control of a user while in the partially open presented position.

7. The power vehicle door system of claim 4, wherein the check actuator allows the check arm to return to the disengaged state as the vehicle door is manually returned from the partially open presented position to the closed position.

8. The power vehicle door system of claim 4, wherein the presenter actuator allows the extensible member to move from the extended position to the retracted position as the vehicle door is manually returned from the partially open presented position to the closed position.

9. The power vehicle door system of claim 1, further including a control module in operable communication with the power presenter assembly and the power door check mechanism, the control module being configured to receive a signal from a sensor and to provide a signal to the power presenter assembly and the power door check mechanism indicating the vehicle door is under manual control of the user.

10. The power vehicle door system of claim 1, wherein the power presenter assembly is mounted on the vehicle door and the power door check mechanism is mounted on the vehicle body.

11. A vehicle door configured for pivoting movement relative to a vehicle body, comprising:
a door panel structure;
a power door system for pivoting the vehicle door relative to the vehicle body from a closed position to a partially open presented position and for selectively holding the vehicle door in the presented open position, the power door system including a power presenter assembly and a power door check mechanism in operable communication with one another, the power presenter assembly being mounted to one of the vehicle body and the door panel structure and having an extensible member and a presenter actuator for actuating movement of the extensible member between a retracted position corresponding to the closed position of the vehicle door and an extended position corresponding to the partially open presented position of the vehicle door, the power door check mechanism being mounted to one of the vehicle body and the door panel structure and having a check arm and a check actuator configured to move the check arm between a disengaged state and an engaged state, the check actuator being configured to maintain the check arm in the disengaged state when the vehicle door is in the closed position and the check actuator being configured to maintain the check arm in the engaged state when the vehicle door is in the partially open presented position.

12. The vehicle door of claim 11, wherein the check actuator is configured to move the check arm from the engaged state to the disengaged state in response to an indication the vehicle door is under manual control of a user.

13. The vehicle door of claim 12, wherein the presenter actuator is configured to move the extensible member from the extended position to the retracted position in response to an indication the vehicle door is under manual control of a user.

14. The vehicle door of claim 12, wherein the check actuator is configured to maintain the check arm in the engaged state in response to an indication the vehicle door is not under manual control of a user while in the partially open presented position.

15. The vehicle door of claim 14, further including a control module in operable communication with the power presenter assembly and the power door check mechanism, the control module being configured to receive a signal from a sensor and to provide a signal to the power presenter assembly and the power door check mechanism indicating when the vehicle door is under manual control of the user and when the vehicle door is not under manual control of the user.

16. A method of controlling movement of a vehicle door between a closed position, a partially open presented position, and an open position relative to a vehicle body with a power door presenter assembly configured to selectively move from a retracted position, corresponding to the vehicle door closed position, to an extended position, corresponding to the partially open presented position, and a power door check mechanism configured to move from a disengaged state to release the vehicle door to an engaged state to selectively hold the vehicle door in the partially open presented position, comprising:
maintaining the power door presenter assembly and the power door check mechanism in a de-activated state corresponding to the retracted position of the power door presenter assembly and the disengaged state of the power door check mechanism while the vehicle door is intended to remain in the closed position;
selectively actuating the power door presenter assembly to move the power door presenter assembly from the retracted position to the extended position to move the vehicle door to the partially open presented position; and
selectively actuating the power door check mechanism in coordination with the actuation of the power door presenter assembly to move the power door check mechanism from the disengaged state to the engaged state to hold the vehicle door in the partially open presented position.

17. The method of claim 16, further including selectively actuating the power door check mechanism to move from the engaged state to the disengaged state in response to an indication that the vehicle door is under the manual control of a user.

18. The method of claim 17, further including selectively actuating the power door presenter assembly to move from the extended position to the retracted position in response to an indication that the vehicle door is under the manual control of a user.

19. The method of claim 18, further including configuring the power door presenter assembly and the power door check mechanism in operable communication with an electronic control module and coordinating actuation of the power door presenter assembly and the power door check mechanism via signals from the electronic control module.

20. The method of claim 19, further including maintaining the power door check mechanism in the engaged state in response to the electronic control module indicating the vehicle door, while in the partially open presented position, is not under manual control of a user.
